(19) United States
(12) Patent Application Publication
(10) Pub. No.: US 2012/0124508 A1
(43) Pub. Date: May 17, 2012

(54) Method And System For A Personal Network

(75) Inventors: David B. Morin, San Francisco, CA (US); Dustin R. Mierau, San Francisco, CA (US); Matthew Van Horn, San Francisco, CA (US); Daniel S. Dofter, San Francisco, CA (US); Mark Lewandowski, San Francisco, CA (US); Daniel Trinh, San Francisco, CA (US); Michael Jackson, San Francisco, CA (US); Lowell Kirsh, San Francisco, CA (US); Matthew M. Matteson, San Francisco, CA (US); Jon Crosby, San Francisco, CA (US)

(73) Assignee: Path, Inc., San Francisco, CA (US)

(21) Appl. No.: 12/945,743

(22) Filed: Nov. 12, 2010

(51) Int. Cl. G06F 3/048

(52) U.S. Cl. 715/781

(57) ABSTRACT

Systems and methods for asynchronous communications within an information sharing platform are provided. Traditional social network models use bi-directional friendship or unidirectional following. In contrast to these models, embodiments of the present invention provide for a unidirectional sharing friendship model. The unidirectional friendship model allows people to share information through a path of communications with a set of recipients selected by the sharer.

### TECHNICAL FIELD

Various embodiments of the present invention generally relate to interactions within information sharing platforms (e.g., a social networking site). More specifically, various embodiments of the present invention relate to systems and methods for asynchronous communications within an information sharing platform.

### BACKGROUND

Social networking sites have become popular for maintaining and expanding relationships. These sites are typically online platforms that are dedicated to building and maintaining the social networks or social relations among people by providing systems for sharing information to many people without requiring the users to take the time to contact these people directly. In many cases, the relationships are established among users who share experiences, common interests, and/or activities.

Many of these sites allow users to create profiles with a variety of information that can be shared with other users who have requested to be friends with each other within the social networking site. These sites usually have privacy controls that allow users to choose who can view their profile, contact them, etc. Through these profiles, the users can upload pictures and movies, share information about their lives, create blog entries, indicate interests of the user, communicate in real-time with other users, comment on content of users, and the like. For example, social networking sites allow for friends (e.g., high school classmates) to remain connected, interact, and share pictures, home movies, interests, hobbies, favorite movies, favorite books, favorite television shows, and other information about their lives.

However, the interactions created by traditional sites often do not create personal interactions. As such, there are a number of challenges and inefficiencies found in traditional social networking sites.

### SUMMARY

Systems and methods are described for asynchronous communications within an information sharing platform. In some embodiments, a graphical user interface screen can be displayed on a display device of a first user in a social network. The graphical user interface screen can include a first window pane and a second window pane for receiving user interactions. For example, the first window pane can include a navigational menu with a path sharing navigational icon and a path feed navigational icon. The second window pane, in response to selection of the path sharing navigational icon, can display a path sharing interface to receive a request from the first user to unidirectionally share a path created by the first user with other users selected by the first user. According to some embodiments, the path created by the first user includes a series of customized messages created by the first user. The second window pane, in response to selection of the path feed navigational icon, can display a path feed interface with unidirectionally shared paths created by one or more other users of the social network. The unidirectionally shared paths can include a variety of information such as, but not limited to, photographs, geographic locations, time stamps, etc. In addition the viewers of the unidirectionally shared paths can select to not view, in the path feed interface, one or more of the paths shared by the other. In some embodiments, the choice to not monitor a path of a sharer can be done without notifying the sharer that the recipient is not viewing the path in the recipient's path feed.

In some embodiments, only a part of a photograph or other customized message is initially displayed in the path feed interface. The cursor movements of the first user are monitored to determine if a cursor has been positioned over or in proximity to the photograph. When the cursor has been positioned over or in proximity to the photograph the entire photograph is displayed. In addition to displaying the entire photograph, viewer images of users of the social network who have seen the entire photograph can also be displayed when the cursor has been positioned over or in proximity to the photograph.

The navigational menu can include other icons. For example, a temporal navigational icon, a geographical navigational icon, and a path creation navigational icon can be used in one or more embodiments of the present invention. In response to a selection of the geographical navigational icon, a geographical map can be displayed in the second window pane. The geographical map can include location indicators of one or more geographic locations included in the unidirectionally shared paths created by the other users. In response to selection of the temporal navigational icon, the path feed interface can be displayed in the second window pane. In this case, however, the path feed interface shows the unidirectionally shared paths created by the other users limited to a preset time period (e.g., today, last 24 hours, etc). In response to selection of the path creation navigational icon, a path creation interface can be displayed in the second window pane. The path creation interface allows the first user to create each message in the series of customized messages by creating text content, tagging the people in a photograph, and/or tagging the photograph with a geographical location.

Embodiments of the present invention also include computer-readable storage media containing sets of instructions to cause one or more processors to perform the methods, variations of the methods, and other operations described herein.

The systems provided by various embodiments can include an account database, a sharing request module, a distribution module, a tagging module, feed module, and/or a cursor module. The account database can be used to store a plurality of user accounts of an internet-based social network. Each of the plurality of user accounts can have a user created path that is unidirectionally shared with other users upon a request by the creator of the path. The sharing request module can be configured to receive a unidirectional path from one or more users of the internet-based social network. Each unidirectional path originates from an originating user and can indicate a recipient list with one or more users selected by the originating user and can include a communication created by the originating user to be shared with the one or more users on the recipient list. Each communication in the unidirectional path can include a variety of messages and information such as, but not limited to, photographs, geographic locations, time stamps, and privacy indicators. The distribution module can be communicably coupled to the sharing request module and configured to access the account database to determine routing information for pushing the unidirectional path of the originating user to the one or more users on the recipient list associated.

The tagging module can be used to tag a photograph included in the communication with people information retrieved from the account database, location information identified by a global positional system, and an activity. In some cases, the tagging module can include or interact with a photo identification system to automatically identify people in the photograph by using information stored in the account database.

The feed module can receive the communication from the distribution module and display the communication on a display device with only a part of the photograph being initially displayed in a path feed interface. The cursor module monitors cursor movements on the display device and determines if a cursor has been positioned over or in proximity to the photograph. The feed module displays the entire photograph when the cursor has been positioned over or in proximity to the photograph. In some embodiments, the feed module displays viewer images of users of the internet-based social network who have seen the entire photograph when the cursor has been positioned over or in proximity to the photograph.

The system in one or more embodiments of the present invention can also include a path feed interface. The path feed interface can allow a user to select to not view one or more of the unidirectionally shared paths created by one or more other users without notifying the one or more other users. The system can also include a graphical user interface generation module to generate a graphical user interface with a path sharing interface, a path feed interface, and a geographical locator interface.

While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

Embodiments of the present invention will be described and explained through the use of the accompanying drawings in which:

FIG. 1 illustrates an example of an internet-based social networking environment in which some embodiments of the present invention may be utilized;

FIG. 2 shows a block diagram with exemplary components of an asynchronous communications system in accordance with one or more embodiments of the present invention;

FIG. 3 is a flow chart illustrating exemplary operations for operating an asynchronous communications system in accordance with various embodiments of the present invention;

FIG. 4 is a flow chart illustrating exemplary operations for creating a path within an asynchronous communications system in accordance with some embodiments of the present invention;

FIG. 5 is a flow chart illustrating exemplary operations for managing paths within an asynchronous communications system in accordance with one or more embodiments of the present invention;

FIG. 6 illustrates an exemplary graphical user interface screen with a path feed interface in accordance with various embodiments of the present invention;

FIG. 7 illustrates an exemplary graphical user interface screen with an expanded message in the path feed interface in accordance with some embodiments of the present invention;

FIG. 8 illustrates an exemplary graphical user interface screen with a geographical locator interface in accordance with one or more embodiments of the present invention;

FIG. 9 illustrates an exemplary graphical user interface screen with a path sharing interface in accordance with various embodiments of the present invention;

FIG. 10 illustrates an exemplary graphical user interface screen with a tagging interface in accordance with various embodiments of the present invention; and

FIG. 11 illustrates an example of a computer system with which some embodiments of the present invention may be utilized.

The drawings have not necessarily been drawn to scale. For example, the dimensions of some of the elements in the figures may be expanded or reduced to help improve the understanding of the embodiments of the present invention. Similarly, some components and/or operations may be separated into different blocks or combined into a single block for the purposes of discussion of some of the embodiments of the present invention. Moreover, while the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

Various embodiments of the present invention generally relate to interactions within information sharing platforms (e.g., a social networking site). More specifically, various embodiments of the present invention relate to systems and methods for asynchronous communications within an information sharing platform. Traditional social network models use bi-directional friendship or unidirectional following. In contrast to these models, embodiments of the present invention provide for a unidirectional sharing friendship model. The unidirectional friendship model allows people to share and build trust in a manner not available in traditional systems.

For example, users of the asynchronous communications system cannot subscribe or request to follow someone or add someone as a friend. Instead, users can only “share” their path with other user. As such, instead of going to a first user's profile and requesting friendship or pressing follow (taking information and adding it to the requesting user's stream) a second user (or sharing user) will instead visit the user's profile and press “share”. This will give the first user access to the sharing user's path. The sharing user's path will then show up in the receiving user's list of people whom are sharing with them. The receiving user will be able to choose if the sharing user's path shows up in their main feed or not. In some embodiments, the receiving user will continue to have access to the sharing user's path until revoked. As such, users will have two lists of people; a receiving user list of people that are receiving the user's path and a list of people that are sharing their path with the user. Users can be mutually sharing with each other, but they do not have to be.

In some embodiments, users of the system will only be able to share their path with a limited number of people (e.g., 50 people or 150 people). Suppose a user of the system had reached the limit for sharing and is unable to share with any other recipients. The user can pause sharing with another user and open up an additional slot thus allowing the user to share with one additional user. In other embodiments, users of the system will be able to share with an unlimited number of people. Additionally, if a recipient of a path doesn't want that another user to show up in their main feed, the recipient can hit the “pause” button so that no new activity will come from the sender.

In the following description, for the purposes of explanation, numerous specific details are set forth in order to provide a thorough understanding of embodiments of the present invention. It will be apparent, however, to one skilled in the art that embodiments of the present invention may be practiced without some of these specific details.

Embodiments of the present invention may be provided as a computer program product which may include a machine-readable medium having stored thereon instructions which may be used to program a computer (or other electronic devices) to perform a process. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

While, for convenience, embodiments of the present invention are described with reference to sharing photographs and other communications through a single path within an internet-based social network, embodiments of the present invention are equally applicable to various other arrangements for sharing information, other types of digital content, and with multiple paths. For example, a user can have a first path dedicated to a first set of recipients (e.g., family) and a second path dedicated to a second set of recipients (e.g., co-workers). As such, the path shared with one set of recipients will not be shared with the other set of recipients unless a particular recipient is a member of both sets.

Also, for the sake of illustration, various embodiments of the present invention have herein been described in the context of computer programs, physical components, and logical interactions within modern computer networks. Importantly, while these embodiments describe various aspects of the invention in relation to modern computer networks and programs, the method and apparatus described herein are equally applicable to other systems, devices, and networks as one skilled in the art will appreciate. As such, the illustrated applications of the embodiments of the present invention are not meant to be limiting, but instead exemplary. Other systems, devices, and networks to which embodiments of the present invention are applicable include, but are not limited to, other types of communication and computer devices and systems. More specifically, embodiments are applicable to mobile communication systems, services, and devices such as cell phone networks and compatible devices. In addition, embodiments are applicable to all levels of computing from the personal computer to large network mainframes and servers.

Terminology

Brief definitions of terms, abbreviations, and phrases used throughout this application are given below.

The terms “connected” or “coupled” and related terms are used in an operational sense and are not necessarily limited to a direct physical connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

The phrases “in some embodiments,” “according to various embodiments,” “in the embodiments shown,” “in other embodiments,” and the like generally mean the particular feature, structure, or characteristic following the phrase is included in at least one embodiment of the present invention, and may be included in more than one embodiment of the present invention. In addition, such phrases do not necessarily refer to the same embodiments or to different embodiments.

If the specification states a component or feature “may”, “can”, “could”, or “might” be included or have a characteristic, that particular component or feature is not required to be included or have the characteristic.

The term “responsive” includes completely or partially responsive.

The term “module” refers broadly to software, hardware, or firmware (or any combination thereof) components. Modules are typically functional components that can generate useful data or other output using specified input(s). A module may or may not be self-contained. An application program (also called an “application”) may include one or more modules, or a module can include one or more application programs.

General Description

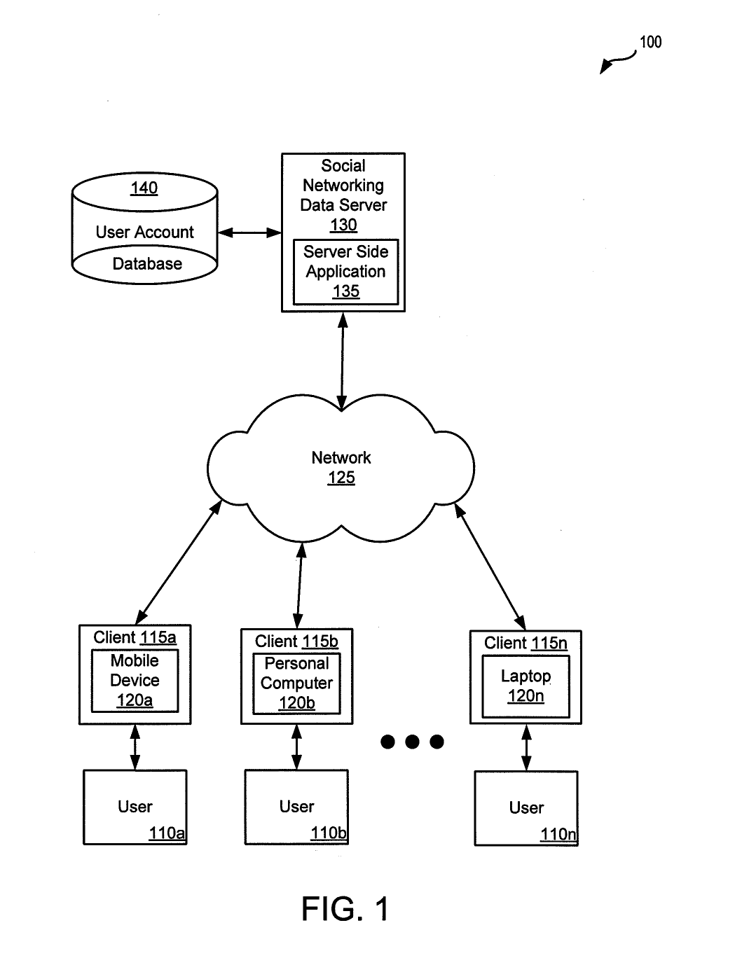

FIG. 1 illustrates an example of an internet-based social networking environment 100 in which some embodiments of the present invention may be utilized. The embodiments illustrated in FIG. 1 show users 110a-110n running clients 115a-115n on mobile device 120a, personal computer 120b, and laptop 120n. Network 125 connects clients 115a-115n (e.g., webpage or custom application) to social networking data server 130 running server side application 135 which is communicably coupled to user account database 140.

Social networking data server 130 hosts an internet-based social network site allowing users 110a-110n access through network 125. The social network site allows users 110a-110n to create profiles or user account which can be stored on user account database 140. Each user profile can include a variety of information that can be shared with other users via the social networking site. Each user can create a path with a series of communications to communicate in real-time with other users and share information. The communications can include uploaded pictures and movies, information about a user's life, a text, a link to a website, indicate interests of the user, comment on content of users, and share other digital information.

Network 125 can be any group of interconnected devices capable of exchanging information. In some embodiments, network 125 may be as few as several personal computers on a Local Area Network (LAN) or as large as the Internet. Network 125 may also be a Voice over Internet Protocol (VoIP) network or a Voice Response Unit (VRU) according to some embodiments of the present invention. In some cases, network 125 may be comprised of multiple networks (private and/or public), even multiple heterogeneous networks, such as one or more border networks, voice networks, broadband networks, service provider networks, Internet Service Provider (ISP) networks, and/or Public Switched Telephone Networks (PSTNs), interconnected via gateways operable to facilitate communications between and among the various networks.

However, in some embodiments, social networking data server 130 and user account database 140 are co-located, and could even be integrated. When server side application is servicing multiple clients 115a-115n, the requests could be processed in a first-in, first out (FIFO) manner. In other embodiments, each user application may be associated with a tier of service that could be purchased. As such, the higher tiers would have a higher priority over the lower tiers of service.

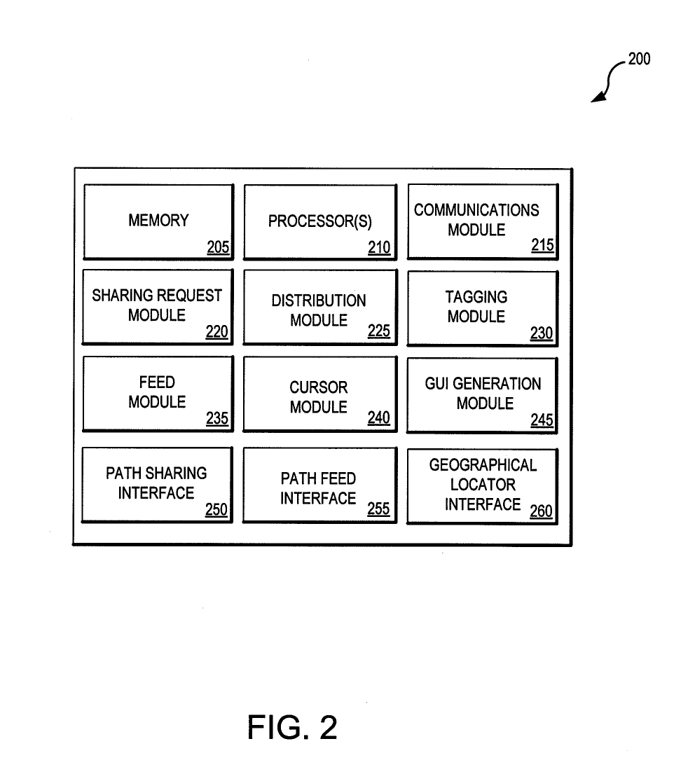

FIG. 2 shows a block diagram 200 with exemplary components of an asynchronous communications system in accordance with one or more embodiments of the present invention. According to the embodiments shown in FIG. 2, the content tagging system can include memory 205, one or more processors 210, communications module 215, sharing request module 220, distribution module 225, tagging module 230, feed module 235, cursor module 240, graphical user interface (GUI) generation module 245, path sharing interface 250, path feed interface 255, and geographical locator interface 260. Other embodiments of the present invention may include some, all, or none of these modules and components along with other modules, applications, and/or components. Still yet, some embodiments may incorporate two or more of these modules into a single module and/or associate a portion of the functionality of one or more of these modules with a different module. For example, in one embodiment, sharing request module 220 can be combined with distribution module 225.

Memory 205 can be any device, mechanism, or populated data structure used for storing information. In accordance with some embodiments of the present invention, memory 205 can encompass any type of, but is not limited to, volatile memory, nonvolatile memory and dynamic memory. For example, memory 205 can be random access memory, memory storage devices, optical memory devices, media magnetic media, floppy disks, magnetic tapes, hard drives, SIMMs, SDRAM, DIMMs, RDRAM, DDR RAM, SODIMMS, erasable programmable read-only memories (EPROMs), electrically erasable programmable read-only memories (EEPROMs), compact disks, DVDs, and/or the like. In accordance with some embodiments, memory 205 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information which can be used as memory 205.

Memory 205 may be used to store instructions for running one or more applications or modules on processor(s) 210. For example, memory 205 could be used in one or more embodiments to house all or some of the instructions needed to execute the functionality of communications module 215, sharing request module 220, distribution module 225, tagging module 230, feed module 235, cursor module 240, graphical user interface (GUI) generation module 245, path sharing interface 250, path feed interface 255, and geographical locator interface 260.

Communications module 215, in accordance with one or more embodiments of the present invention, manages and translates any requests from a user (e.g., received through a graphical interface screen) or application into a format required by the destination component and/or system. Similarly, communications module 315 may be used for communications between modules and/or systems that use different communication protocols, data formats, and/or messaging routines.

Sharing request module 220 can be configured to receive a unidirectional path from one or more users of the internet-based social network. Each unidirectional path originates from an originating user and can indicate a recipient list with one or more users selected by the originating user. The unidirectional path can include a communication created by the originating user to be shared with the one or more users on the recipient list via a display device (e.g., mobile phone). Each communication in the unidirectional path can include a variety of messages and information such as, but not limited to, photographs, text, geographic locations, time stamps, and privacy indicators.

In some embodiments, distribution module 225 can be communicably coupled to the sharing request module and configured to access an account database to determine routing information for pushing the unidirectional path of the originating user to the one or more users on the recipient list associated.

Tagging module 230 can be used to tag a photograph included in the communication with people information retrieved from the account database, location information identified by a global positional system, and/or an activity message. The activity message can be created by the user and/or automatically pulled from a things database and suggested for a user. For example, using the GPS system tagging module 230 may determine that the user is at a coffee shop. An activity message associated with that location (e.g., coffee with friends, scheming with friends, or others) may be retrieved from the database. In some cases, the tagging module can include or interact with a photo identification system to automatically identify people in the photograph by using information stored in the account database.

Once the message is complete, feed module 235 can receive the communication from the distribution module and display the communication on a display device with only a part of the photograph being initially displayed in a path feed interface. Cursor module 240 can be used to monitor cursor movements on the display device and determines if a cursor has been positioned over or in proximity to the photograph. When a determination is made that the cursor has been positioned over or in proximity to the photograph, feed module 235 displays the entire photograph. In some embodiments, feed module 235 can display viewer images of users of the internet-based social network who have seen the entire photograph when the cursor has been positioned over or in proximity to the photograph.

Graphical user interface (GUI) generation module 245, can be used generate one or more GUI screens that allow for interaction with a user of the internet-based social network. In at least one embodiment, GUI generation module 245 generates a graphical user interface with a path sharing interface 250, a path feed interface 255, and a geographical locator interface 260.

Path sharing interface 250 can receive a request from the sharer to unidirectionally share a path created by the user with other users selected by the sharer. Path feed interface 255 displays the unidirectionally shared paths created by the other users. In some embodiments, path feed interface can receive a selection from a recipient to not view one or more of the unidirectionally shared paths created by the other users. Geographical locator interface 260 can generate a geographical map with location indicators identify a recent or current location of one or more other uses that are sharing that information with the recipient. In addition, geographical locator interface 260 cam derive the current location of a sharer from a manual input and/or from a GPS unit associated with the sharer (e.g., in the user's mobile phone). The information can then be added to the path of the sharer.

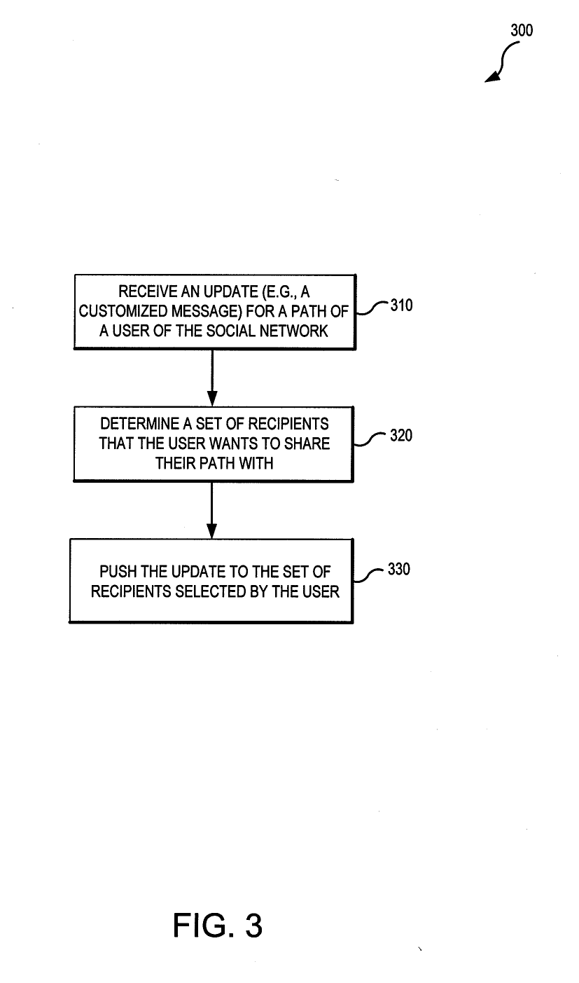

FIG. 3 is a flow chart illustrating exemplary operations 300 for operating an asynchronous communications system in accordance with various embodiments of the present invention. The asynchronous communications system is designed to receive asynchronous communications from a plurality of users. Asynchronous communications generally relate to electronic communications that send information in one direction (e.g., a unidirectional communication or unidirectional path). The asynchronous communications system receives an update (e.g., a customized message) for a path of a user during receiving operation 310. Determination operation 320 determines a set of recipients that the user wants to share their path with. In various embodiments, this information can be embedded within the update at a device of the sharer. In other embodiments, the set of recipients selected by the sharer have been stored on user account database 140. In this case, determination operation will retrieve the set of recipients from the user account database 140. The update is then pushed to the set of recipients in pushing operation 330.

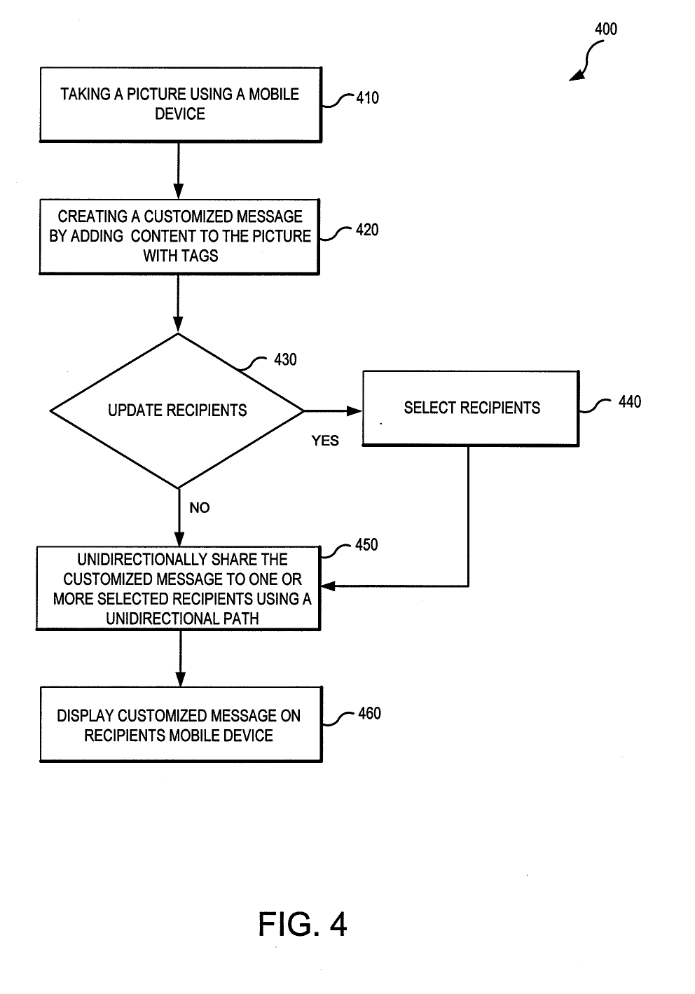

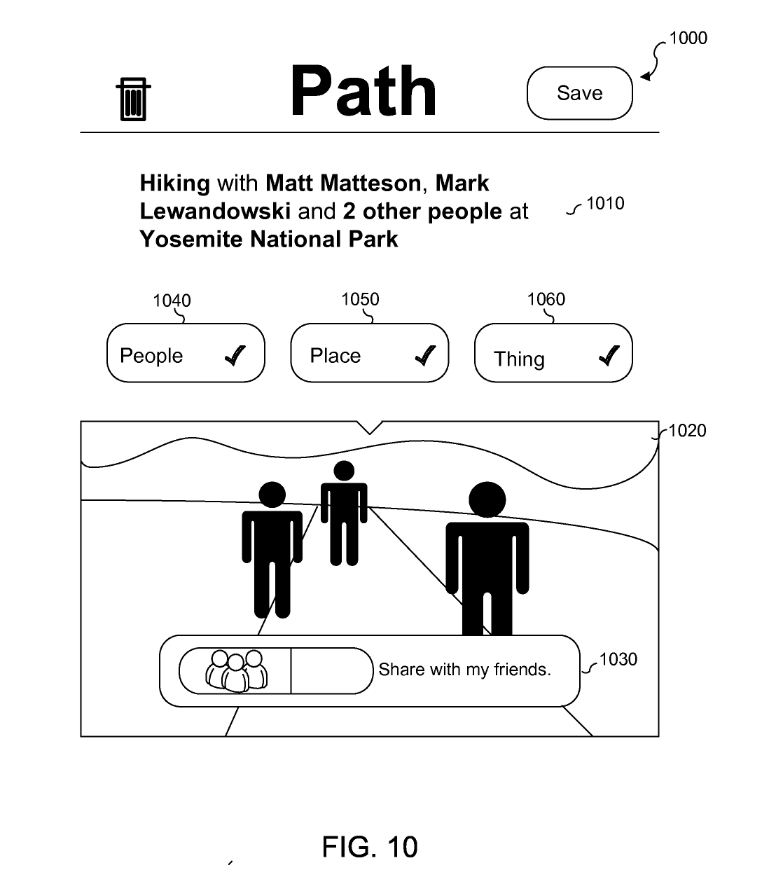

FIG. 4 is a flow chart illustrating exemplary operations 400 for creating a path within an asynchronous communications system in accordance with some embodiments of the present invention. As illustrated in FIG. 4, during picture operation 410 a picture is taken with a mobile device of a sharer. In some embodiments, picture operation 410 can be a selection of a picture or digital image in memory or an upload of a picture or digital image from another device. Once the picture is taken, selected, or received, message creation operation 420 allows the user to create a customized message (e.g., by adding content to the picture with tags). For example, a message creation operation can cause a tagging interface for tagging photos (see, e.g., FIG. 10) to be displayed on the mobile device of the sharer.

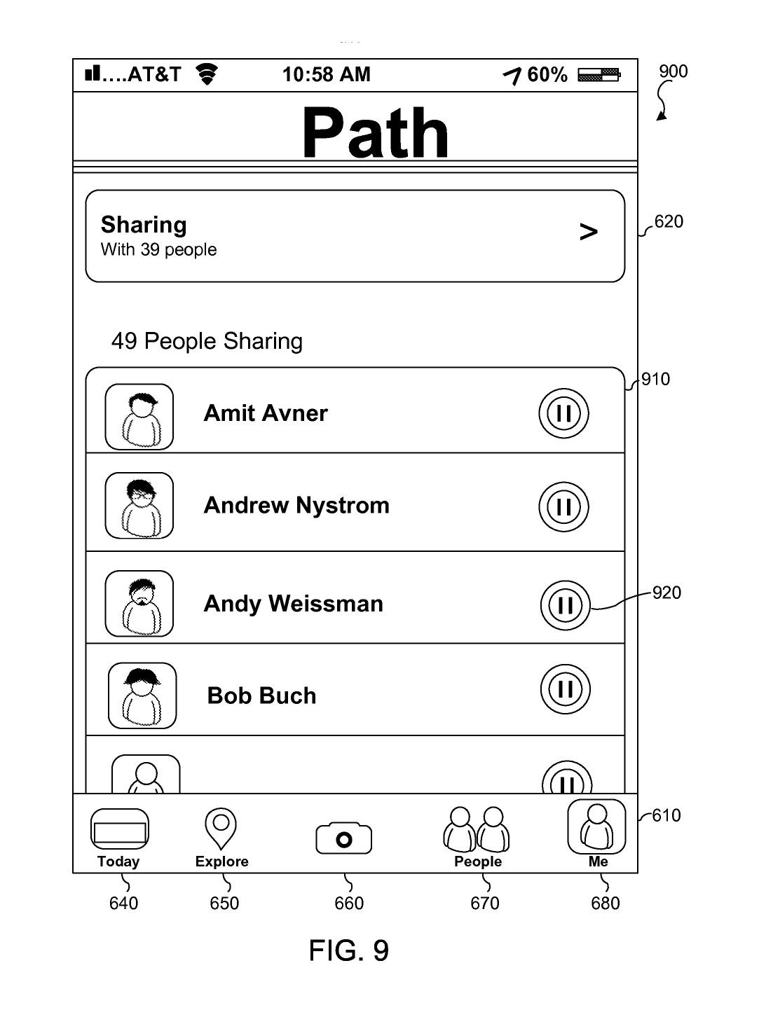

Recipient determination operation 430 monitors for a request from the sharer to update the recipient list. If a request to update the recipient list is received, recipient determination operation 430 branches to recipient selection operation 440. In some embodiments, recipient determination operation 430 can generate and display a path sharing interface (see, e.g., FIG. 9). Through the display path sharing interface the sharer can decide which other users should receive the path created by the sharer. Once the updates are complete, recipient selection operation 440 branches to path sharing operation 450. Similarly, if no request to update the recipient list is received, recipient determination operation 430 branches path sharing operation 450.

Path sharing operation 450 unidirectionally shares the customized message with the selected recipients using a unidirectional path feed of the sharer. These messages are pushed to the recipient list and are displayed on each recipient's display device (e.g., mobile phone) during message display operation 460. In some cases, a recipient may have chosen to not receive the path of the sharer. As such, in various embodiments, message display operation 450 makes a determination (e.g., based on the recipient's preferences) if the customized message should be displayed on each recipient's display device.

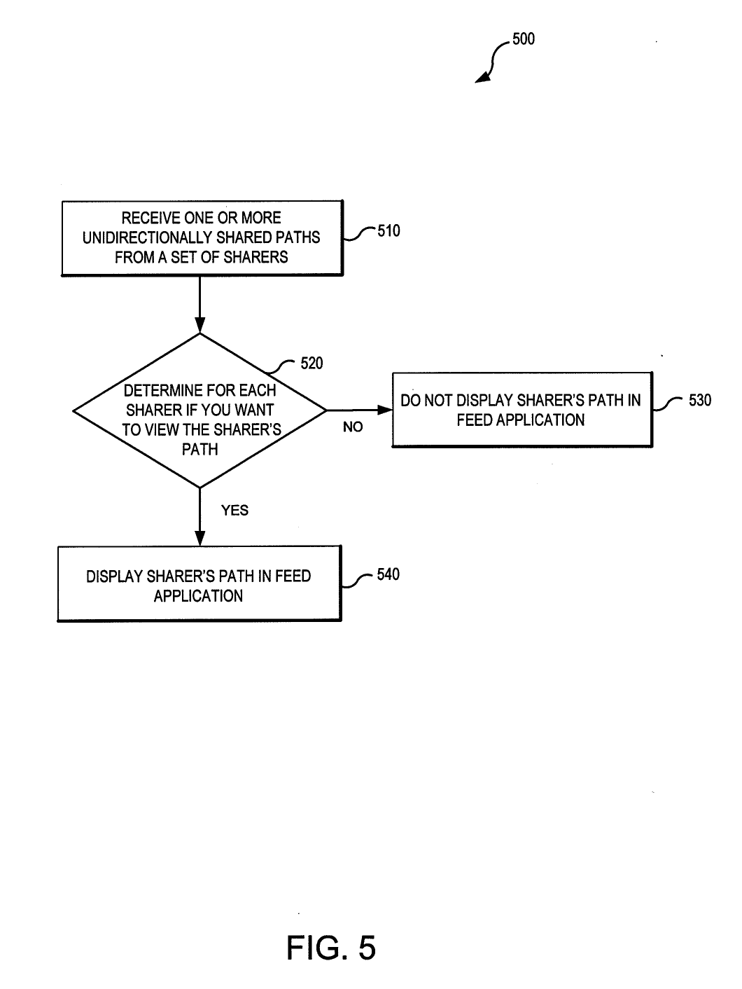

FIG. 5 is a flow chart illustrating exemplary operations 500 for managing paths within an asynchronous communications system in accordance with one or more embodiments of the present invention. During path receiving operation 510, updates (e.g., automatically generated location information, announcements such as a birthday, etc) or customized messages in one or more unidirectionally shared paths from other users are being received. Determination operation 520 determines for each sharer's path that is being pushed to the recipient, if the recipients wants to view the sharer's path. If a determination is made that the recipient does not want to view the path of the sharer, determination operation 520 branches to no display operation 530 where the sharer's path is not displayed in the recipient's path feed interface/application. If a determination is made that the recipient does want to view the path of the sharer, determination operation 520 branches display operation 540 which causes the path of the sharer to be displayed in the recipient's path feed interface/application.

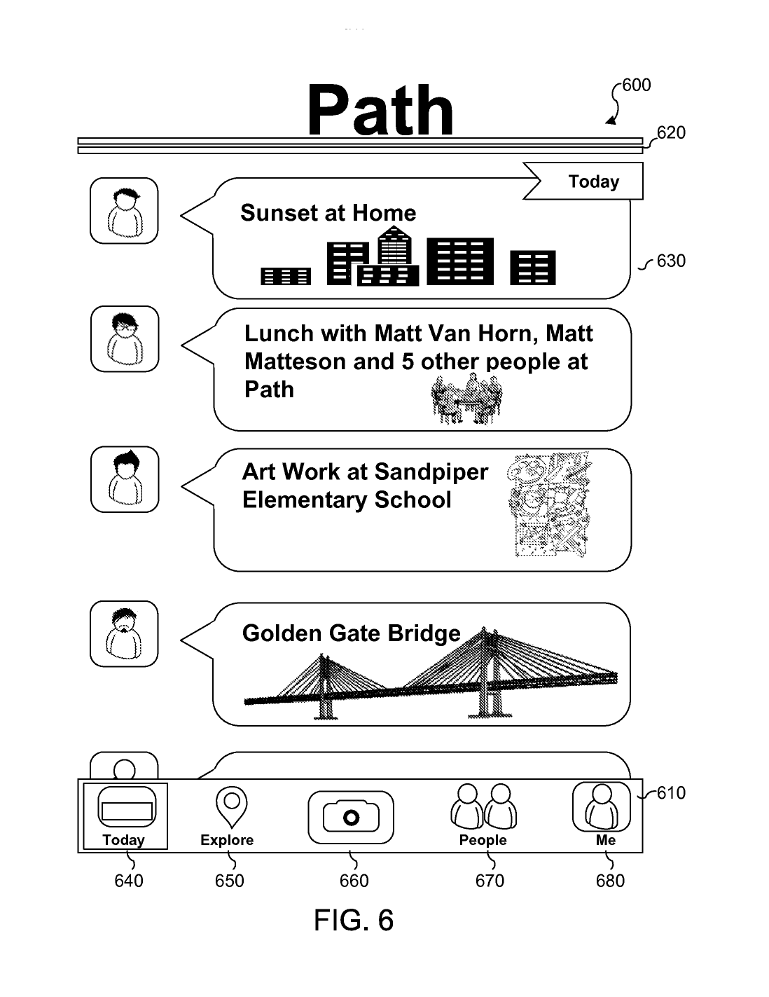

FIG. 6 illustrates an exemplary graphical user interface screen 600 with path feed interface 255 in accordance with various embodiments of the present invention. In the embodiments illustrated in FIG. 6, graphical user interface screen 600 is displayed on a display device of a first user of a social network. Graphical user interface screen 600 includes a first window pane 610 and a second window pane 620 with path feed interface 630. Displayed within first window pane 610 is a temporal navigational icon 640, a geographical navigational icon 650, a path creation navigational icon 660, a path sharing navigational icon 670, and a path feed navigational icon 680. These navigational icons are functionally linked to second window pane 620 and result in different interfaces being displayed.

In FIG. 6, temporal navigational icon 640 has been selected by the user. In response to selection of temporal navigational icon 640, the path feed interface 630 displays the unidirectionally shared paths created by the one or more other users limited to a preset time period. While other embodiments allow for different time periods such as an hour, two hours, etc., FIG. 6 shows the paths limited to a preset time period of today's date.

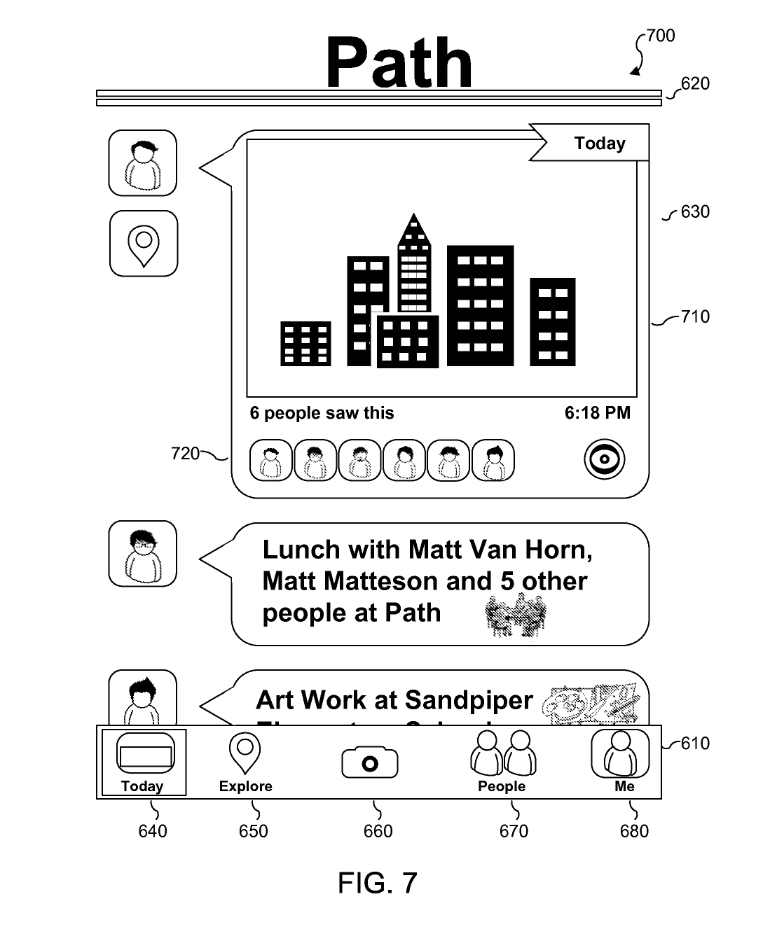

Path feed interface 630 can use cursor module 240 to monitor cursor movements of within the path feed interface and determine if a cursor has been positioned over or in proximity to the photograph. When the cursor has been positioned over or in proximity to the photograph, the entire photograph can be displayed as illustrated in FIG. 7 with expanded message 710.

In accordance with some embodiments, one or more viewer images 720 can be displayed on a photograph or message when recipients have viewed the entire photograph or message. Viewer images can be any representation of a user, such as a picture of a face of a user, a profile picture, an image, an icon, an avatar, or other on-screen representation. In accordance with various embodiments, the viewer image(s) can be placed on the digital image(s) and/or digital content in a variety of ways. For example, the viewer images can be aligned in any fashion or pattern such as, but not limited to, around the perimeter, top, bottom, and/or side of digital image. In addition, some embodiments allow for the viewer images to be modified in one or more ways to convey additional information quickly to the owner. For example, in accordance with various embodiments the viewer images may be grouped, enlarged, shrunk, color coded, animated, have a transparency level imposed, have a color band or ring overlaid or surround the digital content, and/or arranged in certain patterns.

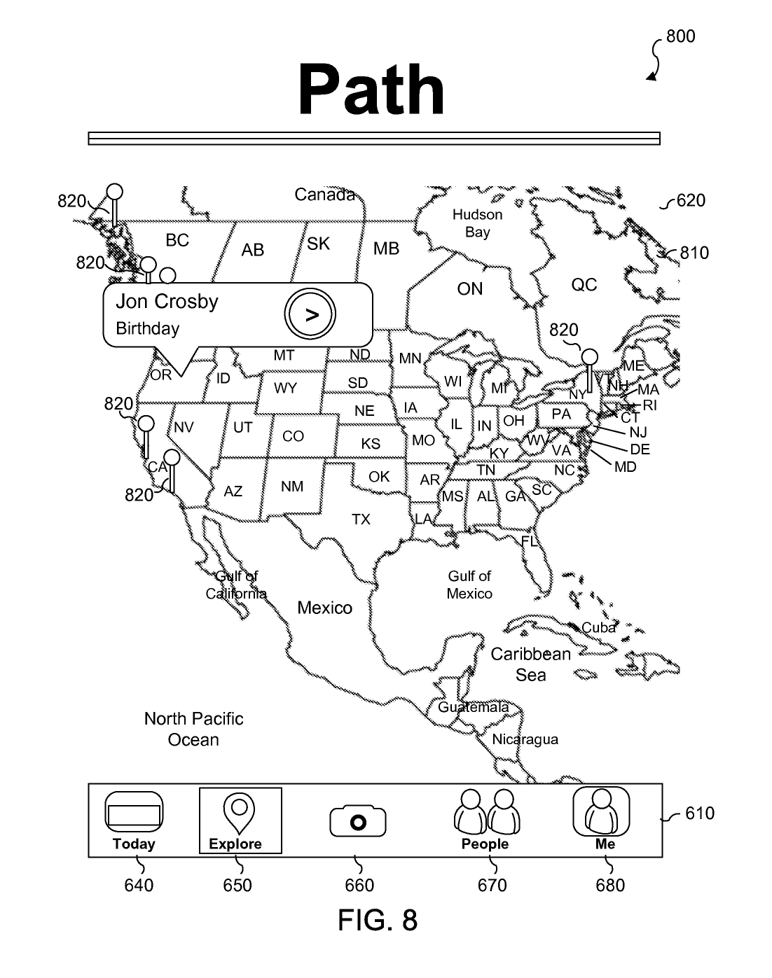

FIG. 8 illustrates an exemplary graphical user interface screen 800 with geographical locator interface 810 in accordance with one or more embodiments of the present invention. Geographical locator interface 810 can be presented in window pane 610 in response to selection of geographical navigational icon 650. As shown in FIG. 8, geographical locator interface 810 includes a geographical map with location indicators 820 of a geographic location included in the one or more unidirectionally shared paths created by other users. The geographic location of the other users can be derived from a manual input from the users and/or a GPS unit associated with the user (e.g., in the user's mobile phone).

FIG. 9 illustrates an exemplary graphical user interface screen 900 with path sharing interface 910 in accordance with various embodiments of the present invention. For example, in response to selection of the path sharing navigational icon 670, path sharing interface 910 is displayed in the second window pane 620 to receive a request from the sharer to unidirectionally share a path created by the user with other users selected. In some embodiments, a check mark can placed next to each person that the sharer has selected as a recipient of the sharer's path. In addition, path sharing interface can be used to allow the user to select which paths are being received from other sharers. The user can “pause” the path of a sharer which results in the sharer's path not showing up in the user's feed. As illustrated in FIG. 9, a pause icon 920 can be displayed with a sharer's path has been paused. Similarly, a check mark can be placed next to a sharer when the sharer's path will be displayed in the user's feed.

The path created by a sharer includes a series of customized messages. In response to selection of the path creation navigational icon, a path creation interface can be displayed which allows the first user to create each message in the series of customized messages by creating text content, tagging the people in a photograph, and tagging the photograph with a geographical location. In some embodiments, the path creation interface can include a tagging interface.

FIG. 10 illustrates an exemplary graphical user interface screen 1000 with tagging interface 1010 in accordance with various embodiments of the present invention. The tagging interface 1010 illustrated in FIG. 10 allows for a sharer to tag photo 1020 and share the photo with the sharer's path using share button 1030. In some embodiments, people icon 1040 allows the user to tag the people in photo 1020. This can be done manually and/or automatically. Similarly, place icon 1050 allows the user to tag photo 1020 with a location that is input manually or automatically determined by a GPS coordinates. In some embodiments, thing icon 1060 can be used to select a activity description from a preset list. In other embodiments, thing icon 1060 is connected to an activity database in which common activities for locations are collected from users and proposed to the sharer.

Exemplary Computer System Overview

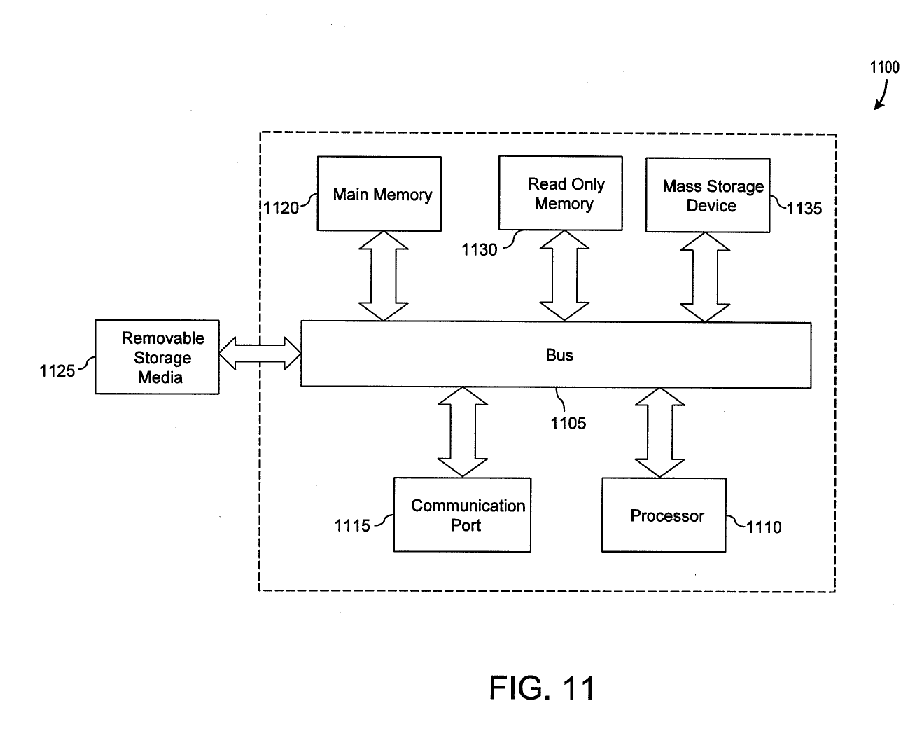

Embodiments of the present invention include various steps and operations, which have been described above. A variety of these steps and operations may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware. As such, FIG. 11 is an example of a computer system 1100 with which embodiments of the present invention may be utilized. According to the present example, the computer system includes a bus 1105, at least one processor 1110, at least one communication port 1115, a main memory 1120, a removable storage media 1125, a read only memory 1130, and a mass storage 1135.

Processor(s) 1110 can be any known processor, such as, but not limited to, an Intel® Itanium® or Itanium 2® processor(s), or AMD® Opteron® or Athlon MP® processor(s), or Motorola® lines of processors. Communication port(s) 1115 can be any of an RS-232 port for use with a modem based dialup connection, a 10/100 Ethernet port, or a Gigabit port using copper or fiber. Communication port(s) 1115 may be chosen depending on a network such a Local Area Network (LAN), Wide Area Network (WAN), or any network to which the computer system 1100 connects.

Main memory 1120 can be Random Access Memory (RAM), or any other dynamic storage device(s) commonly known in the art. Read only memory 1130 can be any static storage device(s) such as Programmable Read Only Memory (PROM) chips for storing static information such as instructions for processor 1110.

Mass storage 1135 can be used to store information and instructions. For example, hard disks such as the Adaptec® family of SCSI drives, an optical disc, an array of disks such as RAID, such as the Adaptec family of RAID drives, or any other mass storage devices may be used.

Bus 1105 communicatively couples processor(s) 1110 with the other memory, storage and communication blocks. Bus 1105 can be a PCI/PCI-X or SCSI based system bus depending on the storage devices used.

Removable storage media 1125 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

The components described above are meant to exemplify some types of possibilities. In no way should the aforementioned examples limit the scope of the invention, as they are only exemplary embodiments.

In conclusion, the present invention provides novel systems, methods and arrangements for asynchronous communications. While detailed descriptions of one or more embodiments of the invention have been given above, various alternatives, modifications, and equivalents will be apparent to those skilled in the art without varying from the spirit of the invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof. Therefore, the above description should not be taken as limiting the scope of the invention, which is defined by the appended claims.

What is claimed is:

1. A method for operating an asynchronous sharing platform, the method comprising:
displaying a graphical user interface screen on a display device of a first user of a social network, the graphical user interface screen including a first window pane and a second window pane;
displaying within the first window pane a navigational menu with a path sharing navigational icon and a path feed navigational icon;
displaying in the second window pane, in response to selection of the path sharing navigational icon, a path sharing interface to receive a request from the first user to unidirectionally share a path created by the first user with other users selected by the first user, wherein the path created by the first user includes a series of customized messages created by the first user; and
displaying in the second window pane, in response to selection of the path feed navigational icon, a path feed interface with unidirectionally shared paths created by one or more other users of the social network.

2. The method of claim 1, wherein the unidirectionally shared paths created by the one or more other users include a photograph, a geographic location, and a time stamp.

3. The method of claim 2, wherein only a part of the photograph is displayed in the path feed interface, the method further comprising:
monitoring cursor movements of the first user to determine if a cursor has been positioned over or in proximity to the photograph; and
displaying the entire photograph when the cursor has been positioned over or in proximity to the photograph.

4. The method of claim 3, further comprising displaying viewer images of users of the social network who have seen the entire photograph when the cursor has been positioned over or in proximity to the photograph.

5. The method of claim 1, wherein the navigational menu includes a temporal navigational icon, a geographical navigational icon, and a path creation navigational icon and the method further comprises:
displaying in the second window pane, in response to a selection of the geographical navigational icon, a geographical map with location indicators of a geographic location included in the one or more unidirectionally shared paths created by the one or more other users;
displaying in the second window pane, in response to selection of the temporal navigational icon, the path feed interface with the unidirectionally shared paths created by the one or more other users limited to a preset time period; and
displaying in the second window pane, in response to selection of the path creation navigational icon, a path creation interface allowing the first user to create each message in the series of customized messages by creating text content, tagging the people in a photograph, and tagging the photograph with a geographical location.

6. The method of claim 1, wherein the path created by the first user includes a photograph, a geographic location, time stamp, and a privacy indicator.

7. The method of claim 1, wherein the first user can select to not view one or more of the unidirectionally shared paths created by the one or more other users in the path feed interface without notifying the one or more other users.

8. A system comprising:
an account database having stored thereon a plurality of user accounts of an internet-based social network, wherein each of the plurality of user accounts have a user created path that is unidirectionally shared with other users;
a sharing request module configured to receive a unidirectional path from one or more users of the internet-based social network, wherein each unidirectional path originates from an originating user, indicates a recipient list with one or more users selected by the originating user, and includes a communication created by the originating user to be shared with the one or more users on the recipient list;
a distribution module communicably coupled to the sharing request module and configured to access the account database to determine routing information for pushing the unidirectional path of the originating user to the one or more users on the recipient list associated.

9. The system of claim 8, further comprising a tagging module to tag a photograph included in the communication with people information retrieved from the account database, location information identified by a global positional system, and an activity.

10. The system of claim 9, further comprising:
a feed module to receive the communication from the distribution module and display the communication on a display device with only a part of the photograph being initially displayed in a path feed interface;
a cursor module to monitor cursor movements on the display device and to determine if a cursor has been positioned over or in proximity to the photograph; and
wherein the feed module displays the entire photograph when the cursor has been positioned over or in proximity to the photograph.

11. The system of claim 10, wherein the feed module displays viewer images of users of the internet-based social network who have seen the entire photograph when the cursor has been positioned over or in proximity to the photograph.

12. The system of claim 9, further comprising a path feed interface allows a user to select to not view one or more of the unidirectionally shared paths created by one or more other users without notifying the one or more other users.

13. The system of claim 9, wherein the tagging module includes a photo identification system to automatically identify people in the photograph by using information stored in the account database.

14. The system of claim 8, wherein each communication in the unidirectional path includes a photograph, a geographic location, a time stamp, and a privacy indicator.

15. The system of claim 8, further comprising a graphical user interface generation module to generate a graphical user interface with a path sharing interface, a path feed interface, and a geographical locator interface.

16. A computer-readable storage medium containing a set of instructions to cause one or more processors to:
display a graphical user interface screen on a display device of a first user of a social network, the graphical user interface screen including a first window pane and a second window pane;
display within the first window pane a navigational menu with a path sharing navigational icon and a path feed navigational icon;
display in the second window pane, in response to selection of the path sharing navigational icon, a path sharing interface to receive a request from the first user to unidirectionally share a path created by the first user with other users selected by the first user, wherein the path created by the first user includes a series of customized messages created by the first user; and
display in the second window pane, in response to selection of the path feed navigational icon, a path feed interface with unidirectionally shared paths created by one or more other users of the social network.

17. The computer-readable storage medium of claim 16, wherein the unidirectionally shared paths created by the one or more other users includes a photograph and the set of instructions further cause the one or more processors to:
monitor cursor movements of the first user to determine if a cursor has been positioned over or in proximity to the photograph; and
display the entire photograph when the cursor has been positioned over or in proximity to the photograph.

18. The computer-readable storage medium of claim 17, wherein the set of instructions further cause the one or more processors to display viewer images of users of the social network who have seen the entire photograph.

19. The computer-readable storage medium of claim 16, wherein the navigational menu includes a temporal navigational icon, a geographical navigational icon, and a path creation navigational icon and the set of instructions further cause the one or more processors to:
display in the second window pane, in response to a selection of the geographical navigational icon, a geographical map with location indicators of a geographic location of one or more users of the social network included in the one or more unidirectionally shared paths created by the one or more other users;
display in the second window pane, in response to selection of the temporal navigational icon, the path sharing interface with the unidirectionally shared paths created by the one or more other users limited to a preset time period; and
display in the second window pane, in response to selection of the path creation navigational icon, a path creation interface allowing the first user to create each message in the series of customized messages by creating text content, tagging people in a photograph, and tagging the photograph with a geographical location.

20. The computer-readable storage medium of claim 16, the set of instructions further cause the one or more processors to monitor for a request from the first user to not view one or more of the unidirectionally shared paths created by the one or more other users in the path sharing interface.
